(19) United States
(12) Patent Application Publication
(10) Pub. No.: US 2015/0278851 A1
(43) Pub. Date: Oct. 1, 2015

(54) METHOD AND SERVER OF PROVIDING ADVERTISEMENT

(71) Applicant: Jeong Gab LEE, Seoul (KR)

(72) Inventor: Jeong Gab LEE, Seoul (KR)

(21) Appl. No.: 14/737,515

(22) Filed: Jun. 12, 2015

Related U.S. Application Data
(63) Continuation of application No. 13/817,144, filed on Mar. 22, 2013.

(30) Foreign Application Priority Data
Aug. 16, 2010 (KR) 10-2010-0078839

(51) Int. Cl. G06Q 30/02

(52) U.S. Cl. CPC G06Q 30/0245; G06Q 30/0273

(57) ABSTRACT

The present invention relates to a method and server for providing advertisements that employ a contest arrangement between a multiple number of advertising items extracted in association with a particular text or image, to draw the interest of the advertisement users and maximize the advertising effect by supplying certain benefits according to the contest rankings.

A method for providing advertisements according to an embodiment of the present invention can include: providing a contest space such that a contest is implemented between a plurality of advertising items when a pointer is positioned on a particular text or image displayed on a webpage, by a contest space provider unit of an advertisement provision server; extracting a plurality of advertising items associated with the particular text or image and including link information, by an extraction unit of the advertisement provision server; displaying the extracted plurality of advertising items in the contest space, by a display unit of the advertisement provision server; determining contest rankings for the plurality of advertising items, by a contest ranking determiner unit of the advertisement provision server; and providing a benefit in correspondence to the determined contest rankings, by a benefit provider unit of the advertisement provision server.

### CROSS-REFERENCE TO RELATED APPLICATION

This application is a continuation of U.S. patent application Ser. No. 13/817,144, filed on Feb. 15, 2013, which is the National Stage filing under 35 U.S.C. 371 of International Application No. PCT/KR2011/005806, filed on Aug. 9, 2011, which claims the benefit of Korean Patent Application No. 10-2010-0078839, filed on Aug. 16, 2010, the contents of which are all hereby incorporated by reference herein in their entirety.

### TECHNICAL FIELD

The present invention relates to a method and server for providing advertisements to the advertisement users through a contest arrangement between multiple advertising items related to a particular text or image.

### BACKGROUND ART

Advertisers employ various methods of advertising for purveying products or services or for promoting a company image, etc. While television or radio may have been the mainstream media for advertising in the past, the rapid popularization of the Internet has led to a growing segment of Internet-based advertisements. Thus, advertising companies and advertising agencies are looking for various methods by which to provide advertisers with efficient modes of advertising through the Internet.

For example, a search portal aims to provide efficient advertising by providing a searcher with advertisements related to the results of a search inputted by the searcher concurrently with the search results. Also, many websites include advertisers' advertising material in the form of a banner exposed at the upper or lower end or at the left or right side for impression.

However, as Internet users come across an unlimitedly large amount of advertisements, there is an effort to block access for unneeded advertisements. Thus, at present, advertisements that only benefit the advertisers would be spurned by the Internet users.

Therefore, there is a need for a system for providing advertisements that can draw the interest of customers and induce them to voluntarily access the advertisements while maximizing the advertising effect for the advertiser in advertising a company image, product, or service, etc.

### DISCLOSURE

### Technical Problem

An aspect of the present invention is to present a method and server for providing advertisements that employ a contest arrangement between a multiple number of advertising items extracted in association with a particular text or image, to draw the interest of the advertisement users and maximize the advertising effect by supplying certain benefits according to the contest rankings.

### Technical Solution

One aspect of the present invention provides a method for providing advertisements that includes: providing a contest space such that a contest is implemented between a plurality of advertising items when a pointer is positioned on a particular text or image displayed on a webpage, by a contest space provider unit of an advertisement provision server; extracting a plurality of advertising items associated with the particular text or image and including link information, by an extraction unit of the advertisement provision server; displaying the extracted plurality of advertising items in the contest space, by a display unit of the advertisement provision server; determining contest rankings for the plurality of advertising items, by a contest ranking determiner unit of the advertisement provision server; and providing a benefit in correspondence to the determined contest rankings, by a benefit provider unit of the advertisement provision server.

Another aspect of the present invention provides a server for providing advertisements that includes: a contest space provider unit configured to provide a contest space such that a contest is implemented between a plurality of advertising items when a pointer is positioned on a particular text or image displayed on a webpage; an extraction unit configured to extract a plurality of advertising items, which are associated with the particular text or image, and which include link information; a display unit configured to display the extracted plurality of advertising items in the contest space; a contest ranking determiner unit configured to determine contest rankings for the plurality of advertising items; a benefit provider unit configured to provide a benefit in correspondence to the determined contest rankings; a database storing information related to the plurality of advertising items and the contest ranking results; and a control unit configured to control the contest space provider unit, the extraction unit, the display unit, the contest ranking determiner unit, the benefit provider unit, and the database overall.

### Advantageous Effects

According to an embodiment of the present invention, a contest space can be provided in which a contest is implemented between a multiple number of advertising items when a pointer is positioned on a particular text or image displayed on a webpage. Thus, an advertisement user can be provided with several advertising items related to a single text or image at once.

According to an embodiment of the present invention, the results of a contest between the multiple advertising items can be provided to the advertisement user, to draw the interest of the advertisement user.

Also, according to an embodiment of the present invention, certain benefits can be provided to the advertiser and the advertisement users in correspondence to the contest results, to thereby induce advertisers to participate in the bidding.

According to an embodiment of the present invention, if an advertiser fraudulently clicks his/her own advertising item, the rate of the advertising fee may be increased, and if the advertiser fraudulently clicks another advertiser's advertising item, the contest ranking of the other advertiser's advertising item may rise, so that false clicks for the advertising items can be prevented and the searcher can be provided with contest rankings having high reliability and accuracy.

### DESCRIPTION OF DRAWINGS

FIG. 1 is a diagram schematically illustrating the structure of a system for providing advertisements related to an embodiment of the present invention.

FIG. 2 is a block diagram illustrating a server for providing advertisements related to an embodiment of the present invention.

FIG. 3 is a flowchart illustrating a method for providing advertisements related to an embodiment of the present invention.

FIG. 4 illustrates a mode of application of an embodiment of the present invention.

### MODE FOR INVENTION

The terms used in the present specification will be examined briefly, before presenting a detailed description of the present invention.

The terms used herein were selected as general terms currently in common usage, in consideration of the functions in the present invention, but their meanings may differ according to the intentions of those skilled in the art, or developments in court precedents or new technology, etc. In certain cases, the terms may have been arbitrarily chosen by the applicant, in which cases the meanings of the terms will be disclosed in the detailed description of the present invention. Thus, it is to be noted that the terms used herein are to be defined not only by the names of the terms but by their meanings and the overall context of the present invention.

Throughout this disclosure, an advertisement refers to a non-confronting paid communication performed to promote the sales of a product or service by introducing the existence, characteristics, and benefits of the product or service to many people and stimulating the desires or needs of consumers, or to increase the general reliability of an advertiser. The advertisement may include product advertising for selling a product, idea advertising for public relations (PR) aimed at promoting business policies, etc., and so on.

Throughout the disclosure, an advertiser refers to an entity conducting an advertising activity. When the advertiser performs advertising through a broadcast medium, the advertiser may include a program provider, i.e. a sponsor. Also, the advertiser may include a prospective client with whom an advertising agency wishes to begin a transaction. The advertiser may include multiple entities.

Throughout the disclosure, a battler refers to an advertiser who wishes to display his/her advertising item in a contest space to compete with other advertising items.

A method and server for providing advertisements related to an embodiment of the present invention will be described below in more detail with reference to the accompanying drawings.

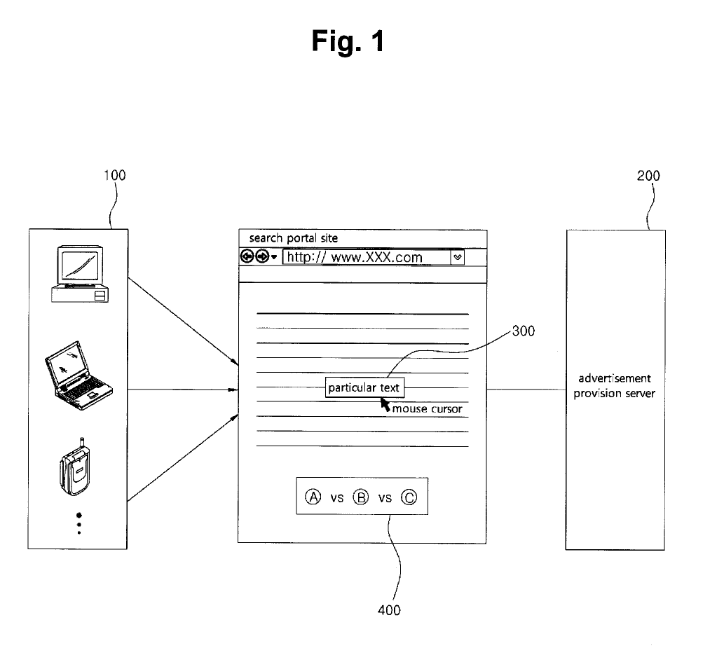

FIG. 1 is a diagram schematically illustrating the structure of a system for providing advertisements related to an embodiment of the present invention.

As illustrated in FIG. 1, according to an embodiment of the present invention, an advertisement user 100 can use a terminal to access a webpage that provides an advertisement related to a particular text or image. The terminal can include fixed terminals as well as mobile terminals.

That is, the terminal can include a personal computer (PC), laptop (notebook) computer, cell phone, smart phone, digital broadcasting terminal, PDA (personal digital assistant), PMP (portable multimedia player), navigation device, e-book terminal, template PC, etc.

The advertisement user 100 can access the webpage through a wired or wireless communication network. When the advertisement user 100 accesses the website using a mobile communication terminal, a communication network (e.g., a 3G network or a 4G network) of a mobile communication provider or WiFi (wireless fidelity) technology can be used. Using the WiFi technology, the advertisement user 100 can access the website for free.

The advertisement user 100 can include a person requesting a search through the webpage, a user of the webpage, and a person purchasing a product from the webpage or a website linked from the webpage, as well as a person simply surfing the web. That is, an advertisement user 100 refers to a person who may be provided with an advertisement related to the text or image.

If the advertisement user 100 clicks a specific item to open a link, the advertisement user may be described as a clicker. Also, if the advertisement user 100 purchases a product through a linked website, the advertisement user may be described as a purchaser.

According to an embodiment of the present invention, the advertisement provision server 200 may manage the entire webpage, or only manage a contest space 400 to provide advertisements to the advertisement user 100.

The contest space 400 can be provided when the pointer is positioned over a particular text or image 300 displayed on the webpage. A particular text may refer to a particular word, a phrase of a particular length, etc. Also, a particular image may be a particular figure, a particular product, a particular trademark, etc.

The particular text or image 300 for which the contest space 400 is provided can be set beforehand, in which case such text or image can be distinguishable from other text or images on the webpage. For example, the particular text or image for which the contest space 400 is provided can be processed by the advertisement provision server 200 to be of a certain color, underlined, boxed, shaded, etc.

According to an embodiment of the present invention, the pointer may refer to an interface element which indicates a position on the screen to which the advertisement user 100 wishes to point. The pointer can include, for example, a mouse cursor, etc. The mouse cursor can be expressed in various forms according to the graphic user interface. For example, the mouse cursor can be expressed as a vertical bar with small bars at the top and bottom, a hand having fingers, a finger shape, a block shape, or various other shapes.

In the case of a touch screen, the advertisement user 100 can touch the display screen directly, to be provided with the contest space 400.

For convenience, the descriptions that follow will be provided using a mouse cursor as an example of the pointer.

The contest space 400 can display a multiple number of advertising items extracted in association with the particular text or image 300. The multiple advertising items can be displayed randomly (by rolling) within the contest space 400 whenever the pointer is newly positioned over the text or image 300. This is to maintain parity between the multiple advertising items in the contest arrangements.

Also, according to an embodiment of the present invention, the advertisement provision server 200 can provide the contest space 400 in the form of an advertising banner 400.

A banner refers to a strip-shaped advertisement that can be seen on Internet sites. This is one of the newer forms of advertisements directed at Internet users, spurred by the rapid increase in the number of Internet users. The advertising banner can include link information. Thus, when the advertisement user 100 clicks an advertising item in the contest space 400 provided in the form of an advertising banner, the advertisement user 100 can be led to a related site.

When the advertisement user 100 accesses the website through a mobile communication terminal, the advertisement provision server 200 can provide the advertisement user 100 with an advertisement through the mobile web or a WAP (wireless application protocol). In this case, the advertisement user 100 can directly touch the particular text or image 300 displayed on the LCD screen or move a pointer to the text or image 300 by way of a user interface, to be provided with the contest space 400.

The mobile web refers to a browsing technology that enables access to a wired website from a mobile terminal. A WAP (wireless application protocol) refers to a communication standard designed to enable a mobile terminal, such as a mobile communication device, a personal portable terminal (PDA), a wireless terminal, etc., to access the Internet.

According to an embodiment of the present invention, the webpage can include a search site, a portal site, a news site, a broadcast site, a blog, an Internet café, a personal homepage, an Internet shopping mall site, etc. That is, the webpage can be regarded as referring to a webpage that includes a particular text or image 300 for which the advertisement user 100 can be provided with a contest space 400.

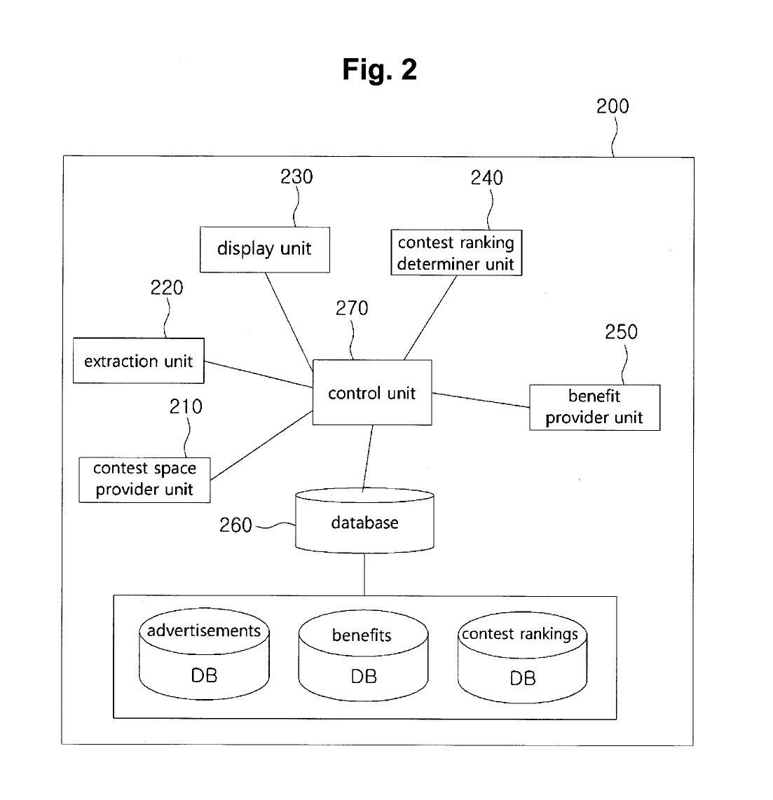

A more detailed description is provided below, with reference to FIG. 2, of the composition of the advertisement provision server 200.

FIG. 2 is a block diagram illustrating a server for providing advertisements related to an embodiment of the present invention.

According to an embodiment of the present invention, the advertisement provision server 200 can include a contest space provider unit 210, an extraction unit 220, a display unit 230, a contest ranking determiner unit 240, a benefit provider unit 250, a database 260, and a control unit 270. In this case, the contest space provider unit 210, the extraction unit 220, the display unit 230, the contest ranking determiner unit 240, and the benefit provider unit 250 can be implemented on a single program cooperating with the control unit 270 or on a program that is separate from the control unit 270.

According to an embodiment of the present invention, when the pointer is positioned over the particular text or image 300, the contest space provider unit 210 can provide the advertisement user 100 with the contest space 400 such that a contest is implemented between multiple advertising items, each of which is associated with the particular text or image and each of which includes link information.

In this case, according to an embodiment of the present invention, the contest space provider unit 210 can automatically adjust the size and position of the contest space 400. According to another embodiment of the present invention, it is also possible to allow the advertisement user 100 to adjust the size and position of the contest space 400.

According to an embodiment of the present invention, when the contest space provider unit 210 provides a contest space 400 for a particular text or image 300, the extraction unit 220 of the advertisement provision server 200 can extract advertising items related to the particular text or image 300 from the database 260.

In this case, the advertising items can be for specific products or services associated with the particular text or image 300, or places of purveyance for the specific products or services. A place of purveyance can include an Internet shopping mall or an Open Market.

An Internet shopping mall refers to a virtual store existing in cyberspace. The Internet shopping mall provides the advantages that the operator pays very little in operating costs, is not limited by customer traffic, and is able to provide product information suited to the consumers' tastes.

An Open Market refers to a mediatory type Internet shopping mall deviating from the regular shopping mall model in that individuals and small businesses, etc., can freely trade products online. That is, the Open Market can involve multiple sales entities. The Open Market can omit the marketing margin, allowing sales at lower costs.

According to an embodiment of the present invention, the multiple advertising items extracted by the extraction unit 220 can be displayed in the contest space 400 by the display unit 230. The display unit 230 can also provide the advertisement user 100 with the contest rankings for the multiple advertising items.

According to an embodiment of the present invention, the contest ranking determiner unit 240 can determine the contest rankings for the multiple number of advertising items in consideration of at least one of click-through rates, sales records, and evaluations of the advertising items.

The click-through rate represents the ratio of the number of clicks to the number of times of impression for each of the advertising items. That is, the click-through rate can be defined as: “click-through rate=click number/impression”.

The term “impression” refers to a particular advertising item being displayed to the advertisement user 100 to allow clicking. According to an embodiment of the present invention, when the multiple advertising items are displayed in the contest space 400, they can be deemed to have been exposed for impression. The recording of the occurrences of impression can be performed by a particular program.

Also, the term “click number” refers to the number of times a particular exposed advertising item was clicked. For example, if the advertisement user 100 clicks on a particular advertising item, the advertisement provision server 200 can maintain a ‘click occurrence record’ for the particular advertising item and ‘information regarding the web page accessed via the click’. In this case, the advertisement provision server 200 can record the click-related information through a particular program.

Thus, the contest ranking determiner unit 240 can identify whether or not there was a click, the click number, whether or not a linked site was accessed, and so on, through the click-related information.

Since the advertising item can include link information, if the advertisement user 100 clicks on a particular advertising item, the advertisement user 100 can be led to the website related to the advertising item, and the advertisement user 100 can purchase a product or service at the linked website.

Thus, an advertisement user 100 may select one of the advertising items presented in the contest space 400, open a link via the link information included in the selected advertising item, and access the linked website to purchase a product; and the sales record can mean the number of products or services purchased by the advertisement users 100.

According to an embodiment of the present invention, the evaluation of an advertising item can mean a value obtained based on points, number of recommendations, comments, product reviews, etc., given by advertisement users 100 evaluating the advertising item.

According to an embodiment of the present invention, the benefit provider unit 250 can provide certain benefits in correspondence to the contest rankings determined above.

A benefit refers to a separate bonus that can be applied to the specific advertising item that is victorious in the contest among multiple advertising items. A benefit can include a discount on the product and service, money accumulation, a discount coupon, mileage accumulation, a free gift, a gift certificates, game money, etc.

The benefits can be provided to advertisement users 100 who open a link through the link information included in the item, access the linked website, and purchase a product or service. Benefits can also be provided to the advertiser of the specific advertising item that is victorious in the contest. In this case, the advertiser can be provided with a benefit such as a discount on the bidding price, a reduced fee for product sales, a priority in advertisements, etc.

Furthermore, the benefit provider unit 250 can also provide a particular benefit even to a clicker who opened a link through the link information included in the item but did not make a purchase. For example, if the advertisement user 100 selected (clicked) item A from the multiple number of items and opened a link, the benefit provider unit 250 can also provide the searcher with a benefit such as point or mileage accumulation, a discount coupon, etc., even if the user does not purchase item A. This is because access to a linked site by an the advertisement user 100 is in itself a fulfillment of the advertiser's goal of advertising.

According to an embodiment of the present invention, the database 260 can store information related to the particular text or images 300 that is to be displayed in a contest space 400, information related to the advertising items associated with the particular text or images 300 displayed in the contest space 400, the contest ranking results determined by the contest ranking determiner unit 240, and the like. The information related to the advertising items can include link information, product information, service information, information regarding the place of purveyance and the advertiser, and the like.

The database 260 can also store information related to the benefits that are to be provided to the advertisement users 100 and the advertisers, etc. The information on the benefits can include information on discount rates based on contest rankings, methods of coupon issuance, methods of point and mileage accumulation, gift certificates, free gifts, prizes, etc.

According to an embodiment of the present invention, the control unit 270 can control the extraction unit 220, display unit 230, contest ranking determiner unit 240, benefit provider unit 250, and database 260 overall.

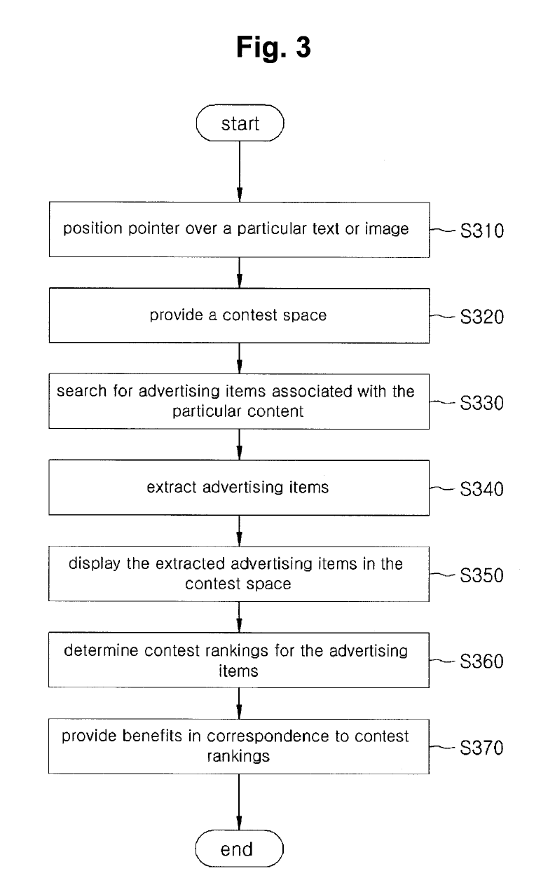

A description is provided below, with reference to FIG. 3, of a method for efficiently providing advertisements related to a particular text or image 300, considered with respect to each component of the advertisement provision server 200.

FIG. 3 is a flowchart illustrating a method for providing advertisements related to an embodiment of the present invention.

According to an embodiment of the present invention, when a pointer is positioned over a particular text or image 300 displayed on a webpage [S310], the contest space provider unit 210 can provide a contest space 400 [S320].

In this case, the extraction unit 220 may search for advertising items stored in the database 260 that are associated with the particular text or image 300 [S330], and may extract a multiple number of advertising items in consideration of the degree of relevance to the text or image 300, the popularity of the advertising items, and bidding price. The bidding price refers to the price proposed at the time of bidding by an advertiser (a battler) who wishes to display his/her advertising item in the contest space 400.

The popularity can be evaluated in consideration of the click-through rate, sales record, number of recommendations, product reviews, etc. The popularity parameter is used for extracting the advertising items that are to be displayed in the contest space 400 and is not related to determining the contest rankings of the advertising items.

Since the contest space 400 is a limited space, the extraction unit 220 may extract the advertising items in a number smaller than or equal to a preset number. For example, the extraction unit 220 can compare the bidding prices of a multiple number of advertising items associated with the particular text or image 300 and extract three advertising items having the highest bidding prices. Furthermore, the extraction unit 220 can also extract the top three items with 30% based on the bidding prices of the advertising items and 70% based on popularity. The extraction unit 220 can also extract the top three advertising items based 100% on the popularity of the advertising items.

Having the extraction unit 220 extract the advertising items based only on the bidding prices might be beneficial to the company operating the advertisement provision server 200, but there could be instances in which the advertisement user 100 is unable to obtain the required advertisement.

Conversely, if the extraction unit 220 extracts the advertising items based only on popularity, the advertisement provision server 200 can provide the advertisement user 100 with customized advertisements. However, the advertiser (battler) who has paid a high bidding price to display his/her advertising item would be put at a disadvantage.

Moreover, having the extraction unit 220 extract the multiple advertising items in consideration of the degree of relevance to the particular text or image 300 can increase the efficiency of advertising by providing the advertisement user 100 with the required advertisement information.

Thus, in a preferred embodiment of the present invention, the extraction unit 220 can, according to circumstances, suitably consider the degrees of relevance to the particular text or image 300, the bidding prices of the advertising items, and popularity parameters in extracting the advertising items that are to be displayed in the contest space 400.

According to an embodiment of the present invention, the display unit 230 can display the extracted advertising items, which are associated with the particular text or image 300, in the contest space 400 [S350]. For the sake of parity, the advertising items can be displayed randomly (by rolling) whenever the pointer is newly positioned over a particular text or image 300.

Thus, according to an embodiment of the present invention, the advertisement provision server 200 can charge the same bidding prices for the multiple advertising items. For example, if the advertisers (battlers) wishing to display their advertising items in the contest space 400 have bid different amounts, the bidding price can be made uniform by fairly adjusting the bidding amounts to the highest bid, the lowest bid, or the average bid, etc., of the extracted multiple number of advertising items.

The display unit 230 can change the positions of the advertising items in the contest space 400 in consideration of popularity of the advertising items. For example, the item that is the most frequently clicked can be displayed by the display unit 230 in real time at a position having the highest advertising effect in the contest space 400. In this case, the advertisement provision server 200 can provide the advertisement user 100 with greater convenience in using the advertisements.

Also, for an advertising item having high popularity, the display unit 230 can display the advertising item at a position of impression desired by the advertiser (battler).

The multiple number of advertising items can include products, services, places of purveyance, and the like. For example, suppose the particular text or image 300 is “laptop”. If the advertisement user 100 points to the particular text or image 300 of “laptop” on the webpage through a user interface, and if the multiple advertising items are products, then types of laptops such as laptop A, laptop B, laptop C, etc., can be displayed in the contest space 400. Also, if the advertising items are services, then repair shop A, repair shop B, repair shop C, etc., can be displayed in the contest space 400. If the multiple items are places of purveyance, then company A, company B, company C, etc., can be extracted for the contest and displayed in the contest space 400. The places of purveyance can include Open Markets.

The contest space 400 which displays the advertising items related to the particular text or image 300 can be positioned near the text or image 300. The advertisement provision server 200 can change the position of the contest space 400 according to the position of the particular text or image 300 on the webpage. For example, if the particular text or image 300 is at an upper part of the webpage, the display unit 230 can position the contest space 400 below the text or image 300, and if the particular text or image 300 is at a right side of the webpage, the display unit 230 can position the contest space 400 to the left of the text or image 300.

The contest ranking determiner unit 240 can determine the contest rankings for the multiple number of advertising items [S360]. The contest rankings can be determined in consideration of at least one of sales records, click-through rates, and evaluations of the advertising items.

For example, the contest ranking determiner unit 240 can determine the contest rankings considering only the click-through rates of the advertising items, determine the contest rankings considering only the sales records of the advertising items, or determine the contest rankings considering only the evaluations of the advertising items. Furthermore, the contest ranking determiner unit 240 can assess the contest rankings with 30% based on click-through rates, 60% based on sales records, and 10% based on evaluations of the advertising items.

In a preferred embodiment of the present invention, the contest ranking determiner unit 240 can consider click-through rates, sales records, and evaluations of the advertising items. For example, supposing the contest space 400 includes products A, B, and C, if the advertisement user 100 clicks on product C to open a link, the contest ranking of product C can be moved higher. Also, if the advertisement user 100 clicks on product C to open a link and concurrently purchases the product C at the linked site, the contest ranking for product C can be upwardly adjusted.

The contest ranking determiner unit 240 can determine the contest rankings for the advertising items in real time or for specific periods. For example, if the contest duration is set for 24 hours from a current time, the contest ranking determiner unit 240 can determine the contest rankings between the multiple advertising items at the points in time when the searchers make purchases. According to another embodiment, the contest ranking determiner unit 240 can determine the contest rankings for each week or each month.

The contest ranking determiner unit 240 can consider the click-through rates, sales records, and evaluations of the advertising items to extract just one advertising item having the highest score as the victorious item, without determining the rankings for the other advertising items. The contest ranking determiner unit 240 can also calculate the scores for all of the multiple advertising items and determine the relative rankings of all of the items.

According to an embodiment of the present invention, the benefit provider unit 250 can provide benefits in correspondence to the contest rankings determined above [S370]. The benefit provider unit 250 can provide different benefits to advertisement users 100 related to the respective advertising items, such as clickers, purchasers, and sellers, etc.

If the contest ranking determiner unit 240 determines the contest rankings for a specific period (e.g. a week or a month), the benefit provider unit 250 can provide the benefits to the advertisement users 100 related to the advertising item that wins the contest.

Also, if the contest ranking determiner unit 240 determines the contest rankings whenever a purchase is made, the benefit provider unit 250 can provide the benefits to the purchaser in real time at the time of purchase.

For example, suppose the contest is held for 24 hours only and there are 7 hours left at the current time. Suppose that, according to the results determined by the contest ranking determiner unit 240, the item in first place at the present time with 7 hours remaining is the item related to A. The advertisement user 100 can access the website linked to item A to purchase item A, and since the item A is the product in first place at the time of purchase, the advertisement user 100 can be provided with the associated benefit (e.g. a discount in the price of the product) in real time.

However, if the contest ranking determiner unit 240 is to determine the contest rankings when all 24 hours have passed, the purchaser at the time of purchase cannot know with certainty whether or not the purchaser will be eligible for the specific benefit, and therefore, the benefit can be provided when the contest duration is completed, such as in the form of point accumulation, etc.

According to an embodiment of the present invention, the benefit provider unit 250 can provide the benefit to the purchasers and seller related to the one item that wins the contest, based on the contest result. According to another embodiment, the benefit provider unit 250 can provide different benefits for the purchasers or seller, etc., related to each item, based on the rankings of the multiple items.

For example, in one embodiment, if the contest results show that product B is in first place, the benefit provider unit 250 can provide a particular benefit only to clickers who clicked on product B or purchasers who purchased product B. In another embodiment, if product B is in first place, product C is in second place, and product A is in third place, the benefit provider unit 250 can offer different benefits, such as by providing 30% discount coupons to advertisement users 100 who purchased product B which ranked first place, providing 20,000 points' accumulation to advertisement users 100 who purchased product C which ranked second place, and providing T-shirts as prizes to advertisement users 100 who purchased product A which ranked third place.

According to an embodiment of the present invention, the benefit provider unit 250 can also provide benefits to clickers who only open links, without making purchases for the advertising items. For example, the benefit provider unit 250 can provide 5% discount coupons to clickers who click on product B ranking first place, to be used later at the linked site. Also, the benefit provider unit 250 can provide coupons for free online photograph prints to clickers who click on product C ranking second place, and provide one dollar in cyber money to clickers who click on product A ranking third place.

The benefit provider unit 250 can provide a benefit not only to purchasers who purchased the product but also to the seller (advertiser) selling the product. For example, the benefit provider unit 250 can apply a particular benefit to the seller selling product B, which ranked first place. According to another embodiment, the benefit provider unit 250 can distribute different benefits also to the sellers of not only product B but also product C, which ranked second place, and product A, which ranked third place. The benefit provided to the advertiser can include a discount on bidding price.

According to an embodiment of the present invention, the benefit provider unit 250 can provide the benefits to the advertiser after a particular amount of time has passed since the beginning of the contest. This is because when only a small amount of time has passed since the beginning of the contest, the contest results can have high error and low reliability. Thus, the benefits can be provided to the advertiser after the contest has started and a particular amount of time has passed.

A more detailed description is provided below of a method for providing advertisements associated with a particular text or image 300 according to an embodiment of the invention.

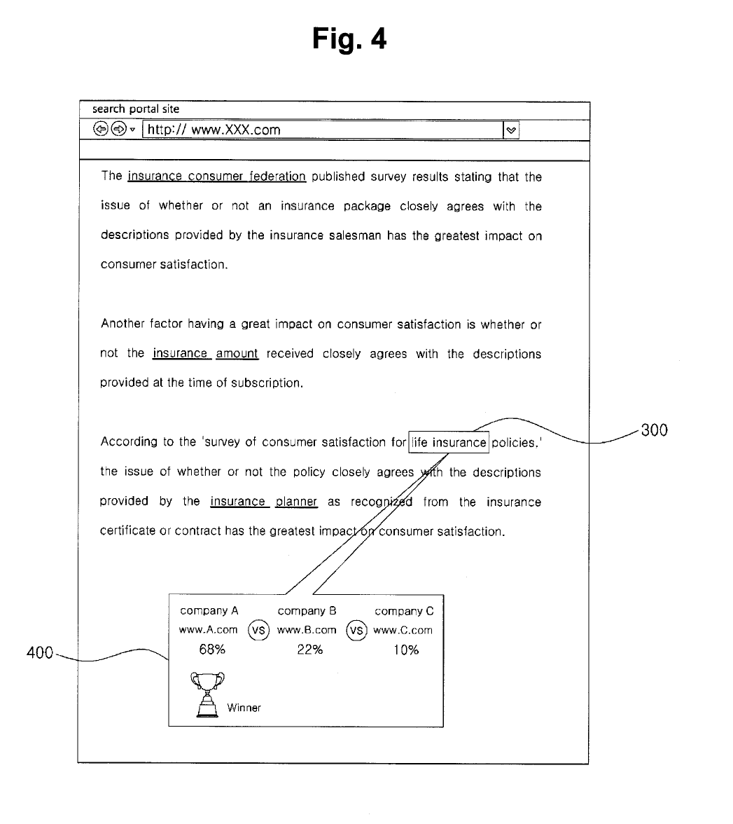

FIG. 4 illustrates a mode of application of an embodiment of the present invention.

According to an embodiment of the invention, the pointer can be positioned over a particular text or image 300, for which a contest space 400 is provided, from within a news article present on the webpage, as illustrated in FIG. 4. The particular text or image 300 for which the contest space 400 is provided can be distinguishable from other text or images. For example, the particular text or image for which the contest space 400 is provided can be processed to be of a certain color such as blue, etc., or be underlined, boxed, or shaded.

In FIG. 4, if the pointer is positioned over “life insurance”, which is the particular text 300 in FIG. 4, the contest space provider unit 210 of the advertisement provision server 200 can provide a contest space 400 to implement a contest between a multiple number of advertising items. Here, the extraction unit 220 can search for advertising items related to life insurance and extract about three advertising items in consideration of the degrees of relevance to life insurance, and the popularity and bidding prices for the advertising items. The display unit 230 may display the extracted advertising items in the contest space 400. In this case, the advertising items can be randomly arranged.

If the extraction unit 220 has extracted company A, company B, and company C, all of which are life insurance providers, and the advertising item of each of the life insurance providers is displayed in the contest space 400, the advertisement user 100 can click one of the advertising items. The advertising items can include link information (access address), so that when the advertisement user 100 clicks on company A, the advertisement user can be led to the website operated by insurance company A. In this case, the advertisement user 100 can purchase a package offered by insurance company A through the website.

The contest ranking determiner unit 240 can determine the rankings for the multiple advertising items according to click-through rates, sales records, and evaluations of the advertising items. Thus, if the advertisement user 100 clicks on company A and purchases a package from company A, the contest ranking for company A can be upwardly adjusted.

The benefit provider unit 250 can provide benefits according to the contest rankings. For example, if company A is in first place with 68%, company B is in second place with 22%, and company C is in third place with 10%, the benefit provider unit 250 can provide benefits to the advertisement users 100 and advertiser associated with company A which won first place, or provide different benefits according to the contest rankings of the advertising items.

The display unit 230 can provide the advertisement users 100 with the contest results in real time. Although the advertisement user 100 may not necessarily click on an advertising item having a high ranking even when the contest ranking results are known, the advertisement user 100 can take the contest ranking results into account when making a purchase.

However, it is also possible to provide the advertisement user 100 with the ranking results after a particular amount of time has passed, instead of showing the rankings of the advertising items from the start. This can provide the advertisement user 100 with search results of higher reliability.

Since knowledge of the contest rankings can be reference material that places the advertisement user 100 at a great advantage, an embodiment of the present invention can involve the advertisement provision server 200 providing the contest ranking results only to advertisement users 100 who meet a certain set of conditions.

For example, the advertisement provision server 200 can provide the contest ranking results only to advertisement users 100 who have joined paid subscriptions. In this case, the advertisement provision server 200 can induce the advertisement user 100 to join a paid subscription and provide personal information for the advertisement user 100 through the subscription information.

According to an embodiment of the present invention, the display unit 230 can display the contest ranking results for the multiple advertising items in the contest space 400, but according to another embodiment, the display unit 230 can provide the contest ranking results through a separate Internet window when the advertisement user 100 clicks on a particular advertising item.

The person skilled in the field of art to which the present invention pertains will understand that the present invention, certain embodiments of which are described above, can be practiced in various implementations without departing from the technical spirit or essential features of the invention.

Therefore, it is to be appreciated that the embodiments disclosed above are for illustrative purposes and do not limit the present invention. The scope of the present invention is to be defined not by the detailed descriptions but by the scope of claims set forth below, and is to be interpreted as encompassing the meanings and scope of the claims as well as all modifications and variations that can be derived from their equivalents.

What is claimed is:

1. A method of managing advertisements, comprising:
providing, by a contest space provider of an advertisement managing server, a contest space for a contest when a pointer is positioned on a particular text or image displayed on a webpage, the contest space including a plurality of advertisement items related to the particular text or image, wherein the advertisement items are simultaneously displayed in the contest space and advertisement fees for the advertisement items in the contest space are same;
randomly changing, by a controller of the server, positions of the advertisement items in the contest space while the contest space is displayed;
constantly updating, by a contest rank determiner of the server, current contest ranks of the advertisement items displayed in the contest space based on a number of clicks on the advertisement items in the contest space during the contest;
constantly displaying, by the controller, the updated current contest ranks of the advertisement items in the contest space in real time during the contest; and
providing, by a benefit provider of the server, a benefit according to the updated contest ranks, wherein the benefit is given to an advertiser of an advertisement item winning the contest and the benefit includes at least one of a discount on an advertisement fee and a discount on sales commission.

2. The method of claim 1, further comprising extracting the plurality of advertising items, by an extracting unit of the server, in consideration of at least one of a popularity, a bid amount, and a degree of relevance to the particular text or image.

3. A server for managing advertisements, the server comprising:
a contest space provider configured to provide a contest space for a contest when a pointer is positioned on a particular text or image displayed on a webpage, the contest space including a plurality of advertisement items related to the particular text or image, wherein the advertisement items are simultaneously displayed in the contest space and advertisement fees for the advertisement items in the contest space are same;
a controller configured to randomly change positions of the advertisement items in the contest space while the contest space is displayed;
a contest rank determiner configured to constantly update current contest ranks of the advertisement items displayed in the contest space based on a number of clinks on the advertisement items in the contest space during the contest, wherein the controller constantly displays the updated current contest ranks of the advertisement items in the contest space in real time during the contest; and
a benefit provider configured to provide a benefit according to the updated contest ranks, wherein the benefit is given to an advertiser of an advertisement item winning the contest and the benefit includes at least one of a discount on an advertisement fee and a discount on sales commission.

4. The server of claim 3, further comprising an extraction unit configured to extract the plurality of advertising items in consideration of at least one of a popularity, a bid amount, and a degree of relevance to the particular text or image.
